(19) United States
(12) Patent Application Publication
(10) Pub. No.: US 2009/0273568 A1
(43) Pub. Date: Nov. 5, 2009

(54) INFORMATION MANAGEMENT AND DISPLAY SYSTEM

(76) Inventor: John Groves Milner, Palm Beach Gardens, FL (US)

Correspondence Address: GOLD & RIZVI, P.A., 600 N. PINE ISLAND ROAD, SUITE 450, PLANTATION, FL, 33324-1311, US

(21) Appl. No.: 12/113,208

(22) Filed: May 1, 2008

(51) Int. Cl. G06Q 30/00; G09G 5/00; G06F 3/041; G09G 3/00

(52) U.S. Cl. 345/173; 345/156; 345/173; 345/30

(57) ABSTRACT

An information management and display system includes a content management server and at least one retailer, a client advertisements server and at least one content display device communicating with the content management server. The client advertisements server is adapted to store advertising information, the content management server is adapted to receive the advertising information from the client advertisements server and the at least one content display device is adapted to receive the advertising information from the content management server and display the advertising information.

### BACKGROUND OF THE INVENTION

### Field of the Invention

The present invention relates generally to distribution of information. More particularly, the present invention relates to an information management and display system which is adapted to retrieve information from a source and render the information accessible for display by one or multiple parties.

### BACKGROUND OF THE INVENTION

Since its inception, the Internet has become a major vehicle for the dissemination of information. The Information is typically posted on websites, which may be devoted to virtually any subject. A major portion of the information, which is available on the Internet, includes advertising information regarding various products and services. Retailers utilize the Internet to advertise and sell millions of products and/or services each year. Typically, a retailer advertises various products and/or services on the retailer's website. Potential customers access the website to view photos, descriptions and cost listings of the products and/or services as well as to order the products and/or services.

A retailer's website typically presents products and/or services which are offered by that particular retailer. Therefore, a potential customer typically must individually access the websites of particular retailers in order to view and consider the products, which are offered by more than one retailer. Under some circumstances, it may be desirable to provide a potential customer or other entity simultaneous access to the photos and/or descriptions of the products and/or services of more than one retailer.

Therefore, an information management and display system which is adapted to retrieve information from multiple sources, such as advertising information from multiple retailers, for example, and render the information accessible for display by one or multiple parties is needed.

### SUMMARY OF THE INVENTION

The invention is directed to an information management and display system.

In one general aspect of the present invention, the information management and display system may include:
a content management server;
   at least one retailer communicating with the content management server;
   a client advertisements server communicating with the content management server;
   at least one content display device communicating with the content management server; and
      wherein the client advertisements server is adapted to store advertising information, the content management server is adapted to receive the advertising information from the client advertisements server and the at least one content display device is adapted to receive the advertising information from the content management server and display the advertising information.

In a further aspect of the present invention, a marketing management entity may communicate with the content management server and may be adapted to modify the advertising information.

In still a further aspect of the present invention, the at least one retailer may be adapted to modify the advertising information.

In another aspect of the present invention, a retailer database server may communicate with the at least one retailer.

In yet another aspect of the present invention, the at least one retailer and the retailer database server may communicate with the at least one content display device.

In still another aspect of the present invention, the advertising information may include at least one of photos, images and descriptive text.

In another aspect of the present invention, the at least one content display device may include a display device housing; a display screen carried by the display device housing; a printed circuit board connected to the display screen; and a power cord connected to the printed circuit board.

In still another aspect of the present invention, the display screen may include a touch-activated display screen.

In a still further aspect of the present invention, the display screen may include a split-screen display screen.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is a perspective view of a content display device of an illustrative embodiment of the information management and display system, more particularly illustrating a capability to rotate advertising images presented on the content display device;

FIG. 2 is a perspective view of an alternative content display device of an illustrative embodiment of the information management and display system;

FIG. 3 is a perspective view of a split-screen version of a content display device of an illustrative embodiment of the information management and display system;

FIG. 4 is a perspective view of a content display device of an illustrative embodiment of the information management and display system, with sales information and advertisements displayed on the display screen of the device;

FIG. 5 is a top view of a content display device of an illustrative embodiment of the information management and display system;

FIG. 6 is a sectional view, taken along section lines 6-6 in FIG. 5, of the content display device;

FIG. 7 is a schematic diagram which illustrates the distribution and display of sales information and advertisements in implementation of an illustrative embodiment of the information management and display system; and

FIG. 8 is a schematic diagram, which illustrates the distribution and display of corporate information and advertisements in implementation of an alternative illustrative embodiment of the information management and display system.

### DETAILED DESCRIPTION OF REPRESENTATIVE EMBODIMENTS

Shown throughout the Figures, the invention is directed to an information management and display system and components of an information management and display system which is adapted to retrieve information from one or multiple sources and render the information accessible for display by one or multiple parties. The information management and display system is particularly suitable for retrieving advertising information such as photos, images and/or descriptions of products and/or services, for example, from multiple retailers or corporations and rendering the information accessible for display by one or multiple parties.

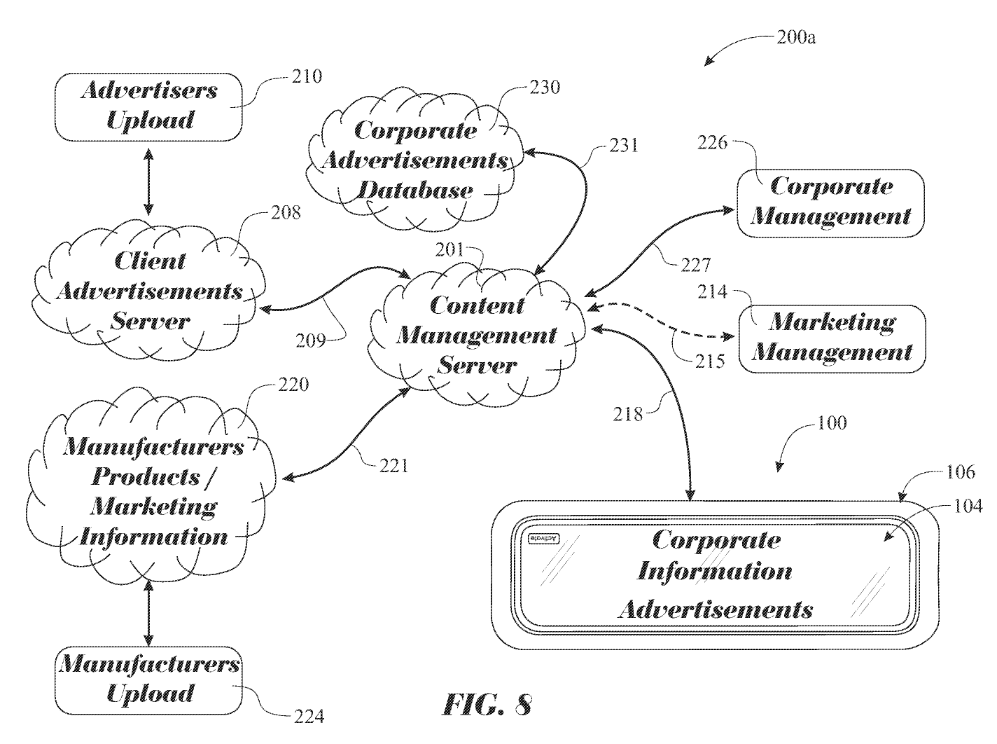

Referring initially to FIG. 7 of the drawings, an illustrative embodiment of the information management and display system, hereinafter system, is generally indicated by reference numeral 200. The system 200 includes a content management server 201. At least one retailer 202 which offers products and/or services may interface with the content management server 201 through a retailer information transfer pathway 203. At least one content display device 100, the details of which will be hereinafter described, interfaces with the content management server 201 through a display device information transfer pathway 218. The content display device 100 may also interface directly with the retailer 202 through a retailer information transfer pathway 206. A retailer database server 204 may interface with the retailer 202 through a database server information transfer pathway 205 for the purpose of supporting a website of the retailer 202. The content display device 100 may interface directly with the retailer database server 204 through a database server information transfer pathway 207.

A client advertisements server 208 may interface with the content management server 201 through a client advertisements server information transfer pathway 209. In application of the system 200, which will be hereinafter described, advertiser uploads 210 of photos, images, descriptive text and/or other information regarding products and/or services that are offered by the retailer or retailers 202 may be made to the client advertisements server 208 for eventual transfer to the content management server 201. A marketing management entity 214 may interface with the content management server 201 through a marketing management information transfer pathway 215 for purposes, which will be hereinafter described.

The content management server 201 is adapted to receive advertising information from the client advertisements server 208 through the client advertisements server information transfer pathway 209, marketing management information from the marketing management entity 214 through the marketing management information transfer pathway 215 and retailer information from each retailer 202 through the retailer information transfer pathway 203. The advertising information that is stored on the client advertisements server 208 may be received from an advertising agency or entity (not illustrated) through the advertiser uploads 210. The advertising information stored on the client advertisements server 208 may include such information as photos, images and/or descriptive text which are directed to products and/or services offered by each retailer 202. The advertising agency or entity may be the same or may be a different entity than the retailer 202 the products and/or services of which are described by the advertising information.

The marketing management entity 214 and each retailer 202 may have the capability to augment, modify and/or edit, for marketing presentation purposes, the advertising information which was previously received from the client advertisements server 208 and is stored on the content management server 201. The resulting modified and/or edited and completed advertising information is transferred from the content management server 201, through the display device information transfer pathway 218 to each content display device 100 for display thereon, as will be hereinafter described.

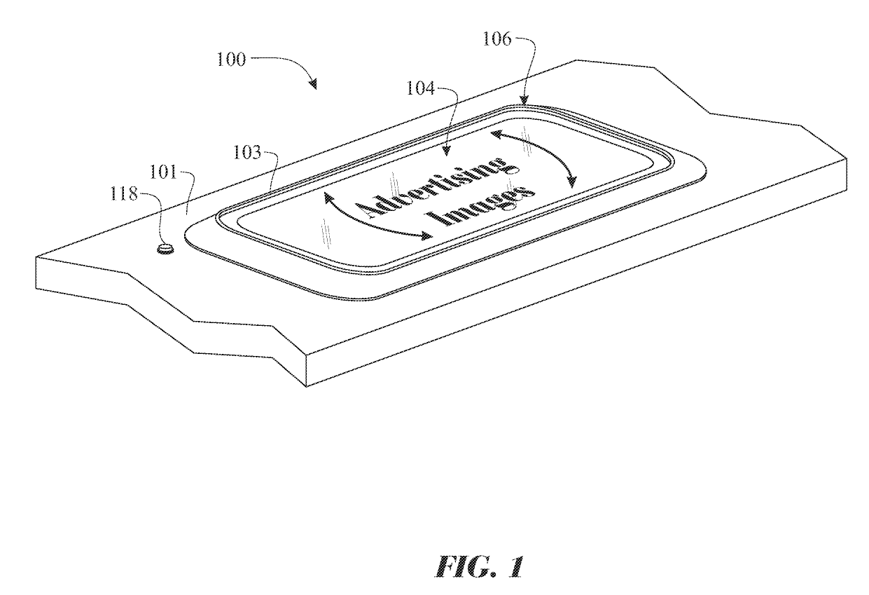

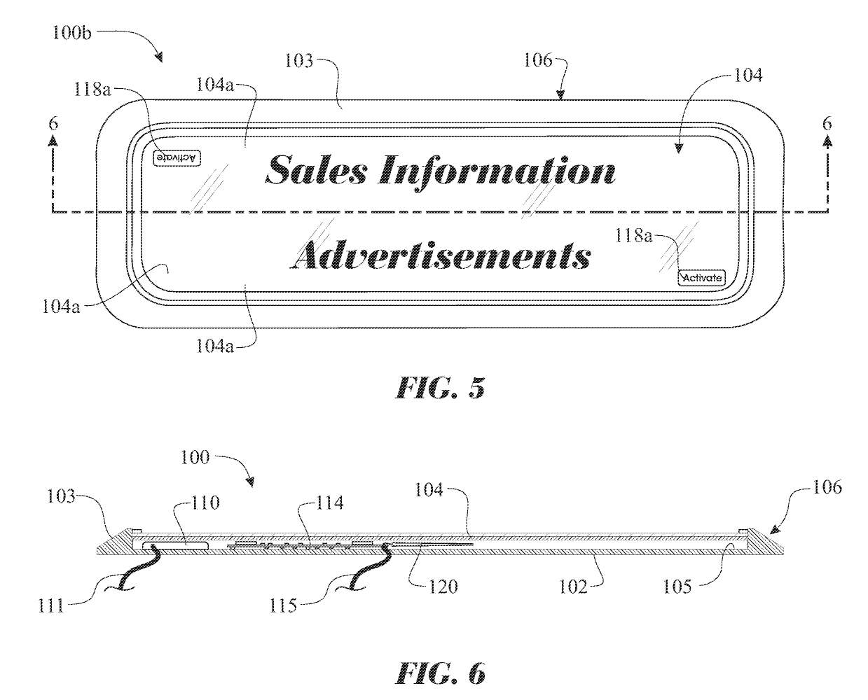

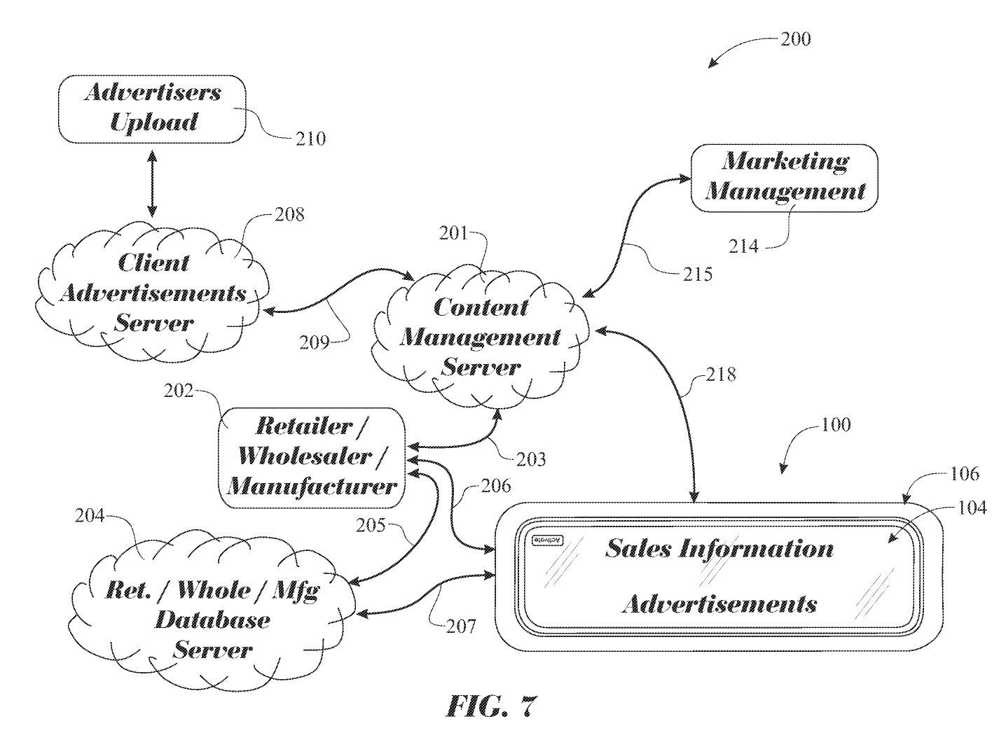

Referring next to FIGS. 1-6 of the drawings, illustrative embodiments of the content display device 100 are illustrated. As illustrated in FIGS. 1 and 6, the content display device 100 may be provided on a suitable display device support 101 (illustrated in section in FIG. 1). As illustrated in FIG. 6, the content display device 100 includes a display device housing 106 having a display device rear panel 102 and a display device frame 103, which extends around the perimeter of the display device rear panel 102. As illustrated in FIG. 1, in some embodiments the display device frame 103 may have a generally elongated, rectangular shape.

A display screen 104 is provided in the display device frame 103. In some applications the display screen 104 may be a touch-controlled display screen, in which case operation of the content display device 100 is facilitated by touching of the display screen 114. As illustrated in FIG. 6, the display device rear panel 102; the display device frame 103; and the display screen 104 together define a display device interior 105. A power distribution module 110 is provided in the display device interior 105. A power cord 111 (illustrated in section) is electrically connected to the power distribution module 110 and extends from the display device housing 106.

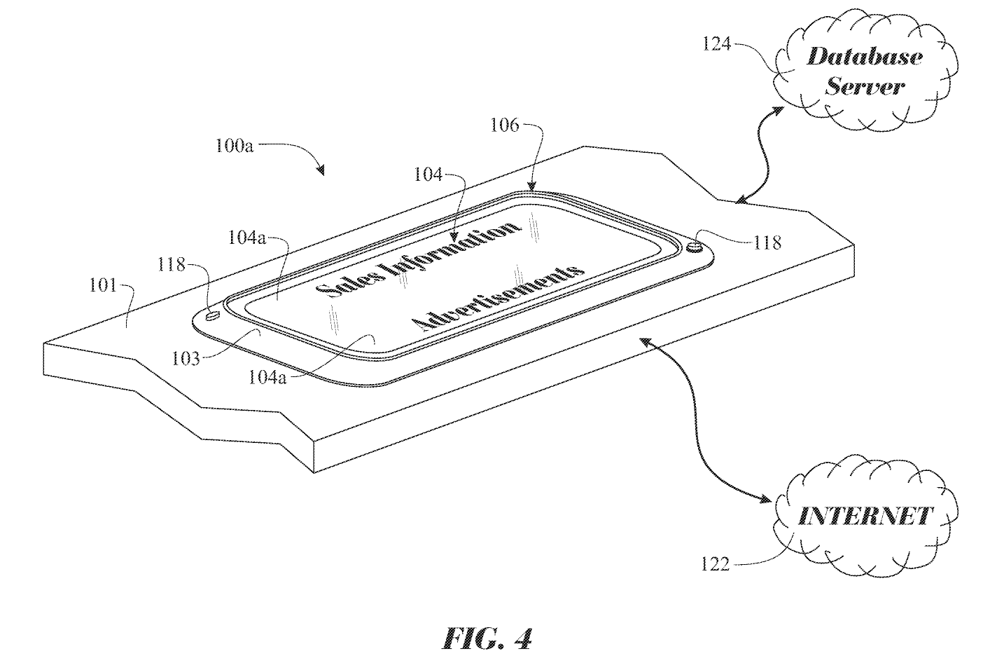

A printed circuit board (PCB) 114 is provided in the display device interior 105 and is connected to the power distribution module 110 and the display screen 104. An Ethernet cable 115 may be connected to the PCB 114 and extend from the display device housing 106 for connection of the content display device 100 to the Internet 122 (FIG. 4) and/or to various database servers 124 (FIG. 4). Additionally or alternatively, an antenna 120 may be connected to the PCB 114 and extend typically into the display device interior 105 for connection to the Internet 122 and/or the database servers 124. In the system 200, the Ethernet cable 115 and/or the antenna 120 define the links of communication between the display device 100 and the retailer information transfer pathway 206 (FIG. 7), the database server information transfer pathway 207 and the display device information transfer pathway 218. The antenna 120 is adapted to receive information wirelessly through the retailer information transfer pathway 206 (FIG. 7), the database server information transfer pathway 207 and the display device information transfer pathway 218.

The PCB 114 includes the various components, which initiate and sustain operation of the content display device 100, according to technology, which is well known by those skilled in the art. The PCB 114 is adapted to receive the completed advertising information from the content management server 201 (FIG. 7) through the display device information transfer pathway 218 (via the Ethernet cable 115 and/or the antenna 120) and display the information on the display screen 104. Accordingly, the PCB 114 may present the completed advertising information in the form of advertising images, for example, on the display screen 104 as illustrated in FIG. 1. The advertising images may correspond to photos or images of various products offered by a retailer 202 (FIG. 7) in implementation of the system 200. The PCB 114 may have the capability to run a flash application that has the capability to continually update and display completed advertising information on the display screen 104.

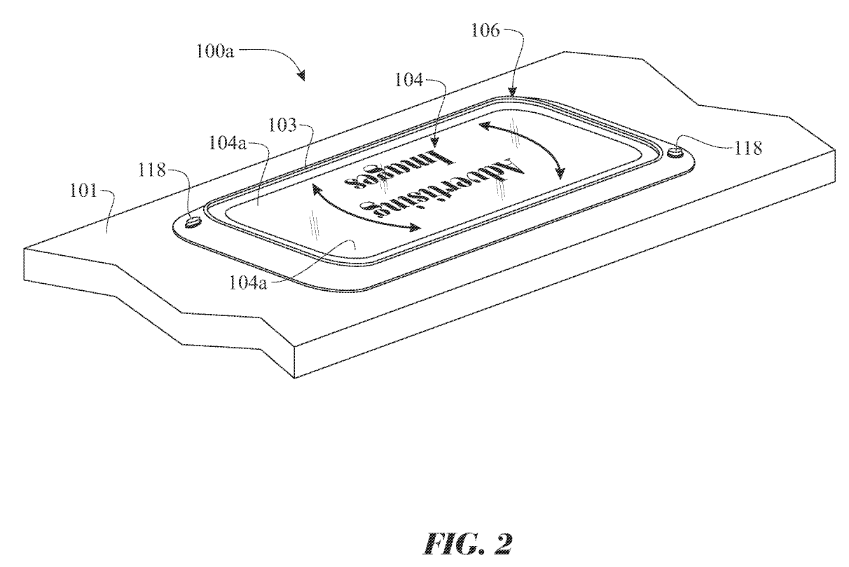

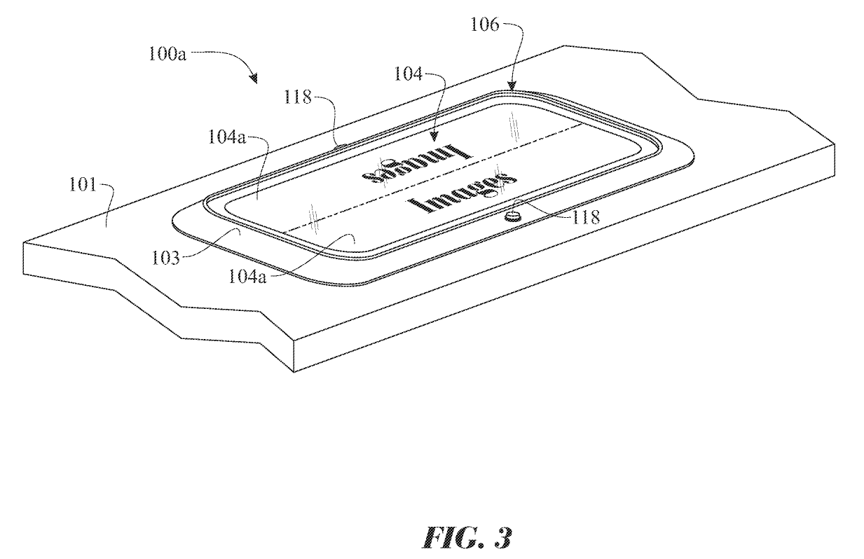

The content display device 100 may include the capability to facilitate selective 180-degree rotation of the advertising images on the display screen 104. This may be facilitated by touching of the display screen 104, for example. As illustrated in FIGS. 2 and 3, in some embodiments of the system 100a, the PCB 114 may be adapted to present a split-screen image display configuration on the display screen 104 and may include a pair of screen sections 104a for this purpose. The respective screen sections 104a may be oriented to display advertising images for viewing from opposite sides of the display device support 101, for example. As illustrated in FIG. 4, the PCB 114 may be additionally adapted to display the completed advertising information on the display screen 104 in the form of sales information and advertisements in textual and/or visual form. In some applications, each content display device 100 may also have the capacity to modify the advertising information responsive to user input.

A power button 118 (FIG. 1) may be connected to the power distribution module 110 (FIG. 6) to facilitate selective activation and deactivation of the display screen 104. As illustrated in FIG. 1, in some embodiments the power button 118 may be provided on the display device support 101. Alternatively, the power button 118 may be provided on the display device frame 103 or other element of the display device housing 106. As illustrated in FIGS. 2 and 3, in the content display device 100a, a pair of power buttons 118 may be provided on respective sides of the display device frame 103 which correspond to the positions of the split screen sections 104. Alternatively, the power buttons 118 may be provided on respective sides of the display device support 101. The power buttons 118 are adapted to facilitate selective activation and deactivation of the respective screen sections 104a of the display screen 104. In still another embodiment of the system 100b illustrated in FIG. 5, a touch screen power button 118a may be provided on each of the screen sections 104a of the display screen 104 to facilitate selective turning of the respective screen sections 104a on and off by touching of the respective touch screen power buttons 1118a.

Referring again to FIG. 7 of the drawings, in typical application of the system 200, each of multiple clients (not illustrated) who desires to display the advertising information which relates to the products and/or services of one or more of the retailers 202 subscribes to use the system 200. Each client creates an account on the website which is hosted by the content management server 201 in order to facilitate access to the advertising information. The advertising information of the retailers 202 is loaded onto the client advertisements server 208 via the advertiser uploads 210. The advertising information stored on the client advertisements server 208 may include such information as photos, images and/or descriptive text which are directed to products and/or services offered by each of the typically multiple retailers 202. The marketing management entity 214 may augment, modify and/or edit the advertising information, which is stored on the content management server 201 for marketing presentation purposes. Each retailer 202 may also augment, modify and/or edit the advertising information of the retailer 202, which is stored on the content management server 201 to suit the advertising needs of the retailer 202. The modified and/or edited and completed advertising information is transferred from the content management server 201, through the display device information transfer pathway 218 to each content display device 100 for display thereon. Accordingly, each client can access and display the completed advertising information in the form of photos, images and/or textual description on the display screen 104 of the content display device 100 by operation of the client's content display device 100.

The content display device 100 of each client may have the capability to create a list of retailers 202 the products and/or services of which the client desires to have the option to display on the display screen 104 of the client's content display device 100. For example, the client may be able to choose 30˜40 named images for display on the display screen 104. By actuation of the touch-activated display screen 104, the client may present the list of retailers 202, and the products and/or services offered by the retailers 202, on the display screen 104. The content display device 100 may have the capability to open an image of a selected product, for example, to the full size of the display screen 104 when the client selects the image for display. Additionally, the content display device 100 may have the capability to zoom in on various areas of the image and move among various locations on the image. In some applications, a flash application running on the content display device 100 may receive real-time updates on the advertising information and present the updated information on the display screen 104. In some applications, each client may also modify the advertising information such as by operation of the touch-screen controls of the display screen 104. Each content display device 100 may be configured to display additional items such as, for example, a calculator; a calendar; links to display other content; and/or a clock with the capability to select one of multiple time zones.

Referring next to FIG. 8 of the drawings, an alternative illustrative embodiment of the information management and display system is generally indicated by reference numeral 200a. In the system 200a, a corporate advertisements database 230 interfaces with the content management server 201 through an information transfer pathway 231. A manufacturer products/marketing information server 220 interfaces with the content management server 201 through an information transfer pathway 221. Manufacturer uploads 224, which may include technical and/or marketing information (hereinafter product information) regarding a manufacturer's products, may be made to the manufacturer products/marketing information server 220 for eventual transfer of the product information to the content management server 201 through the information transfer pathway 221. A corporate management entity 226 interfaces with the content management server 201 through a corporate management information transfer pathway 227.

In typical application, the system 200a facilitates the management and display of information regarding a corporation as well as product information and advertisements, which promote products manufactured and sold by the corporation on each of multiple content display devices 100. Accordingly, a manufacturer (not illustrated) of the corporation's products uploads the product information directed to the corporation's products (block 224) to the manufacturer products/marketing information server 220. The product information may include technical and/or marketing information of the products. The product information is transferred to the content management server 201 through the information transfer pathway 221.

Product advertising information regarding the products offered by the corporation (hereinafter product advertising information) may be loaded onto the client advertisements server 208 via the advertiser uploads 210. The product advertising information stored on the client advertisements server 208 may include such information as photos, images and/or descriptive text, which are directed to the products offered by the corporation. Corporate advertisement information may be transferred from the corporate advertisements database 230 to the content management server 201 through the information transfer pathway 231.

The marketing management entity 214 may augment, modify and/or edit one or more of the product information, the product advertising information and the corporate advertising information, which are stored on the content management server 201 for marketing presentation purposes. The corporate management entity 226 of each corporation may also augment, modify and/or edit one or more of the product information, the product advertising information and the corporate advertising information, which are stored on the content management server 201 to suit the needs of the corporation. The modified and/or edited and completed product information, product advertising information and corporate advertising information is transferred from the content management server 201, through the display device information transfer pathway 218 to each content display device 100 for display thereon. Accordingly, each client can selectively access and display the completed product information, product advertising information and corporate advertising information in the form of photos, images and/or textual description on the display screen 104 of the content display device 100 by operation of the client's content display device 100. Clients may have complete or limited capability to edit or modify the product information, product advertising information or corporate advertising information depending on the application.

While the preferred embodiments of the invention have been described above, it will be recognized and understood that various modifications can be made in the invention and the appended claims are intended to cover all such modifications which may fall within the spirit and scope of the invention.

I claim:

1. A content display device, comprising:
a display device housing;
a display screen carried by said display device housing;
a printed circuit board connected to said display screen;
at least one database server storing information connected to said printed circuit board; and
wherein said printed circuit board is adapted to receive said information from said at least one database server and display said information on said display screen.

2. The content display device of claim 1 wherein said display screen comprises a touch-activated display screen.

3. The content display device of claim 1 wherein said display screen comprises a split display screen comprising a pair of screen sections.

4. The content display device of claim 1 further comprising an Ethernet cable connected to said printed circuit board and said at least one database server.

5. The content display device of claim 1 further comprising an antenna connected to said printed circuit board and adapted to receive said information wirelessly from said at least one database server.

6. An information management and display system, comprising:
a content management server;
at least one retailer communicating with said content management server;
a client advertisements server communicating with said content management server;
at least one content display device communicating with said content management server; and
wherein said client advertisements server is adapted to store advertising information, said content management server is adapted to receive said advertising information from said client advertisements server and said at least one content display device is adapted to receive said advertising information from said content management server and display said advertising information.

7. The system of claim 6 further comprising a marketing management entity communicating with said content management server and adapted to modify said advertising information.

8. The system of claim 6 wherein said at least one retailer is adapted to modify said advertising information.

9. The system of claim 6 further comprising a retailer database server communicating with said at least one retailer.

10. The system of claim 9 wherein said at least one retailer and said retailer database server communicate with said at least one content display device.

11. The system of claim 6 wherein said advertising information comprises at least one of photos, images and descriptive text.

12. The system of claim 6 wherein said at least one content display device comprises a display device housing, a display screen carried by said display device housing, a printed circuit board connected to said display screen and a power cord connected to said printed circuit board.

13. The system of claim 12 wherein said display screen comprises a touch-activated display screen.

14. An information management and display system, comprising:
a content management server;
a client advertisements server communicating with said content management server;
at least one content display device communicating with said content management server;
a manufacturers products/marketing information server communicating with said content management server; and
wherein said client advertisements server is adapted to store advertising information, said manufacturers products/marketing information server is adapted to store product information, said content management server is adapted to receive said advertising information from said client advertisements server and said product information from said manufacturers products/marketing information server and said at least one content display device is adapted to receive said advertising information and said product information from said content management server and display said advertising information and said product information.

15. The system of claim 14 further comprising a corporate advertisements database communicating with said content management server and wherein said content management server is adapted to receive corporate advertisement information from said corporate advertisements database and said at least one content display device is adapted to receive said corporate advertisement information from said content management server and display said corporate advertisement information.

16. The system of claim 15 further comprising a corporate management entity communicating with said content management server and adapted to modify said product information, said advertising information and said corporate advertisement information.

17. The system of claim 14 further comprising a marketing management entity communicating with said content management server and adapted to modify said product information, said advertising information and said corporate advertisement information.

18. The system of claim 14 wherein said advertising information comprises at least one of photos, images and descriptive text.

19. The system of claim 14 wherein said at least one content display device comprises a display device housing, a display screen carried by said display device housing, a printed circuit board connected to said display screen and a power cord connected to said printed circuit board.

20. The system of claim 19 wherein said display screen comprises a touch-activated display screen.
